(19) United States
(12) Patent Application Publication
(10) Pub. No.: US 2023/0235472 A1
(43) Pub. Date: Jul. 27, 2023

(54) ELECTROCOATING (E-COATING) ON A PART BY PART BASIS

(71) Applicant: Divergent Technologies, Inc., Los Angeles, CA (US)

(72) Inventors: Finley Hugh MARBURY, Hermosa Beach, CA (US); Michael Thomas Kenworthy, Rancho Palos Verdes, CA (US); Alex James Hamade, Redondo Beach, CA (US)

(21) Appl. No.: 18/158,948

(22) Filed: Jan. 24, 2023

Related U.S. Application Data
(60) Provisional application No. 63/303,909, filed on Jan. 27, 2022.

(51) Int. Cl. C25D 5/48; C09J 9/02; C25D 11/02

(52) U.S. Cl. CPC C25D 5/48; C09J 9/02; C25D 11/02; C09J 2301/314; C09J 2301/416

(57) ABSTRACT

The instant disclosure describes example techniques for bonding multiple metal structures prior or subsequent to application of a protective coating (e.g., an electrocoating or e-coating) to the structures. In certain aspects, the structures may include one or more attachment points for attaching a single structure or multiple structures bonded together to a clamp or other suitable means for applying an electrical current to the structure(s).

### CROSS-REFERENCE TO RELATED APPLICATIONS

This application claims priority to U.S. Provisional Application No. 63/303,909 titled “PROCESS FOR ELECTROCOATING (E-COATING) ON A SMALLER PART BY PART BASIS WITH THE GOAL OF CORROSION PROTECTION FOR DAPS NODE ASSEMBLIES,” filed Jan. 27, 2022, which is assigned to the assignee hereof, and incorporated herein by reference in its entirety as if fully set forth herein.

### BACKGROUND

### Field

The present disclosure relates to electrocoating (e-coating) metal structures and bonding e-coated structures.

### Background

Electrocoating (e-coating) is process typically used in the automotive industry to protect metal structures (e.g., metal chassis or suspension components) from premature failure due to corrosion. The e-coating process generally starts by applying a pretreatment to a structure's surface to clean the surface (e.g., remove any process lubricant residue, remove any oxide layer formed on the surface, etc.) of the structure. Then, coating materials (resins, pigments, additives, etc.) may be dispersed in a liquid and held in a bath. The structure is then immersed in the bath and an electrical current is passed through the bath using the structure as an electrode. The electrical activity around the surface of the structure draws the coating materials into contact with the structure, causing a layer of resin—including any pigments and additives present—to adhere to the surface of the structure. The coated structure can then be removed from the bath, and the coating cured by baking the structure in an oven to make the coating hard and durable.

As discussed, e-coating requires electrical continuity through the structure while it is submerged in the bath. In conventional systems, this is accomplished by a system of racks/baskets to hold the structure, and clamps and/or wires configured to apply a voltage to the structure. However, connecting wiring to a structure is a manual process that may delay the application of an e-coating to the structure. Moreover, wiring or clamping a structure will typically mar the coating on the structure due to their connection to, and submersion in the bath with, the structure. Notwithstanding the foregoing, the clamps are typically submerged in the bath with the structure to ensure that the entire structure is coated. However, because the clamps are applying a voltage, they too may become coated in the coating materials. Thus, cleaning the coating off of the clamps requires additional time and manual labor to complete an e-coating process.

Furthermore, e-coating is typically performed on metal structures that are completed. For example, multiple individual parts that are relatively small on their own may be welded to each other to form a completed chassis, sub-frame, or other part-aggregated structure. The structure is typically e-coated after completion or partial completion of the structure so that the coating does not prevent or interfere with welding the individual parts together that form the structure. However, e-coating a completed or partial completed structure will typically require relatively large baths to accommodate the size of the structure.

### SUMMARY

Certain aspects are directed to an apparatus. In one example, the apparatus includes a first metal structure at least partially covered by a first protective coating. In another example, the apparatus includes a second metal structure at least partially covered by a second protective coating. In another example, the apparatus includes a material bonding the first metal structure to the second metal structure, wherein the material forms an adhesive layer between the first protective coating of the first metal structure and the second protective coating of the second metal structure.

Certain aspects are directed to a method. In some examples, the method includes applying a first protective coating to a first metal structure. In some examples, the method includes applying a second protective coating to a second metal structure. In some examples, the method includes applying a material to bond the first metal structure to the second metal structure, the material forming an adhesive layer between the first protective coating of the first metal structure and the second protective coating of the second metal structure.

Certain aspects are directed to a method. In some examples, the method includes applying an electrically conductive material to a first attachment point of a first metal structure and to a second attachment point of a second metal structure. In some examples, the method includes curing the material by applying electromagnetic (EM) radiation to the material, wherein the cured material forms an adhesive layer between the first attachment point and the second attachment point, and wherein the cured material provides electrical continuity between the first metal structure and the second metal structure.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIGS. 1A-D illustrate an example powder-bed fusion (PBF) system during different stages of operation.

FIG. 2 illustrates a perspective view of an example assembly system, which includes a plurality of robots configured to perform various example operations for assembly of at least a portion of a vehicle.

FIGS. 3A and 3B are perspective views of a first structure and a second structure.

FIG. 4 is a flow diagram illustrating an example method for coating multiple metal structures and bonding the multiple coated structures.

FIGS. 5A-5C are block diagrams illustrating example metal structures having attachment points to be used for attaching a source of electricity.

FIGS. 6A and 6B are example perspective views of a first retention portion of a first metal structure and a second retention portion of a second metal structure.

FIG. 7 is a flow diagram illustrating an example method for bonding multiple metal structures and coating the bonded metal structures with a protective e-coating.

FIG. 8 is a flow diagram illustrating an example method for bonding multiple metal structures that have already been coated with a protective e-coating.

### DETAILED DESCRIPTION

The detailed description set forth below in connection with the appended drawings is intended to provide a description of various example embodiments of the concepts disclosed herein and is not intended to represent the only embodiments in which the disclosure may be practiced. The detailed description includes specific details for the purpose of providing a thorough and complete disclosure that fully conveys the scope of the concepts to those skilled in the art. However, the disclosure may be practiced without these specific details. In some instances, well-known structures and structures may be shown in block diagram form, or omitted entirely, in order to avoid obscuring the various concepts presented throughout this disclosure.

As discussed above, an electrocoating (e-coating) process typically requires the use of clamps and/or wires to apply a voltage to a metal structure being coated. For example, the clamps and/or wires may be attached to the structure and configured to apply a voltage across the structure to cause cathodic/anodic electrodeposition coating of the structure. However, because the wire and the clamp are necessarily attached to the structure being coated, their presence may obscure parts of the surface area of the structure. Moreover, removing the wire and clamp is a manual process that can mar the coating of the structure.

Thus, aspects of the disclosure are directed to techniques for e-coating a structure that prevent or eliminate obscuring portions of the structure meant to be e-coated, and techniques that prevent coating of clamps used to grasp and apply a voltage to the structure. In one example, the structure may be designed and manufactured to include a removable or breakable portion of the structure to which a clamp can be attached. The breakable portion may be a part of the structure that is added to the design of the structure, and that is configured to break away from the structure after the structure has been coated. In some examples, if the structure is manufactured using additive manufacturing techniques, the design of the structure (e.g., a computer-aided drawing (CAD) file) may be modified to include the breakable portion such that it is attached to the structure. As such, the breakable portion may be manufactured to be more brittle or have a weaker tensile strength relative to the rest of the structure.

In some examples, the breakable portion may be added to the structure after manufacturing of the structure. In such an example, the design of the structure may not require modification. Instead, the breakable portion may be added to the manufactured structure by, for example, tack welding the breakable portion to the manufactured structure. It should be noted that the breakable portion may be attached to an internal and/or an outer/external surface of the structure using any suitable method. Thus, the breakable portion may be removed after the coating of the structure.

In some examples, the breakable portion may be support structure of the structure. Support structures may be used to prevent warping of the structure during additive manufacturing but are no longer necessary after manufacturing of the structure. Thus, the structure may include a support structure that can be used as a temporary location to which a clamp, hook, or any other suitable mechanism may be attached to the structure to provide voltage. After the structure is coated, the support structure may be removed from the structure. In some examples, the design (e.g., CAD file) of the support structure may be modified so that it can accommodate the clamp and/or so that the clamp is not submerged in the coating bath.

In certain aspects, the clamp or other suitable mechanism may be attached to a “permanent” portion of the structure for e-coating. That is, a portion of the structure that is not designed or intended to be removed after manufacturing. In some examples, the design of the structure may be modified to alter the size and/or shape of the permanent portion more amenable to the clamp. In another example, the design of the structure may be modified to alter the mechanical characteristics of the permanent portion (e.g., making the permanent portion thicker, stronger, altering ductility of the portion, altering density of the portion, and/or altering the material of the portion relative to the rest of the structure).

In certain aspects, a determination of whether to use a permanent portion (e.g., an existing feature of the structure) or a breakable portion (e.g., adding an additional piece to the structure) may be determined on a part-by-part basis. Factors for consideration may include: (i) an orientation of the part when determining where to attach a clamp; (ii) costs associated with materials and design changes to add a breakable portion of the structure; (iii) whether an internal feature of the structure may be used as a permanent portion to which the clamp may be attached.

In some examples, the breakable portion and the dedicated portion may not be submerged in the bath of water and coating materials during the coating of the structure. That is, the breakable portion and the dedicated portion may remain outside of the bath. In such an example, a clamp that is attached to the breakable portion or dedicated portion will not be affected (e.g., coated) by the coating materials, and thus, will not have to be cleaned after each use. In the case of the breakable portion, after coating and curing the coating of the structure, the breakable portion may be removed or broken off the structure. A user may apply a protective coating to site of removal/break if the site is meant to be coated. However, in some examples, the site may be part of an internal region of the structure or some other region of the structure that does not require a protective coating. The dedicated portion may also be part of an internal region of the structure or some other region of the structure that does not require a protective coating or may be a portion of the structure that should not be coated (e.g., where bare metal is necessary for connecting to another structure and/or electrical continuity between the structure and another structure).

As discussed, it may be advantageous to apply an e-coating to a plurality of individual structures prior to assembling the plurality of individual structures into a completed product. For example, because the plurality of individual structures are relatively smaller than the completed product, the amount of physical space required to perform an e-coating process on just the structures can be much smaller than a space required for e-coating a completed product (e.g., an full/portion of a chassis). As such, e-coating individual structures may provide a more economical approach assembling and transporting a structure. However, when individual structures are e-coated prior to assembly of the completed product, caution may be needed to keep certain portions/regions of the individual structures from being coated. For example, if two structures are to be welded/glued together after e-coating, the surfaces to be welded should not be coated. In another example, ensuring bare metal contact surfaces to be used to connect two or more structures can ensure electrical continuity through the completed product via the contact surfaces. This provides a significant advantage for chassis grounding in automobiles.

Thus, in certain aspects, individual structures may be e-coated by attaching a clamp to a permanent portion of the structure, where that permanent portion may be used later as a bare metal connecting surface to another structure. Stated differently, the clamp that provides a voltage to the structure may also be utilized as a barrier to prevent the e-coating material from covering that portion of the structure. As such, structures that are e-coated in this manner will have bare metal surfaces to which another structure may be attached. In some examples, the structures may be attached by their respective bare metal portions by welding and/or conductive adhesive.

For example, in an assembly environment, a robot may be used to affect a structural connection between a first structure and a second structure. For instance, the robot may apply a structural adhesive to at least one of the bare metal surfaces of the first and structures before or after joining the first and second structures by their bare metal surfaces. In some examples, a quick-cure, electrically-conductive ultra-violet (UV) adhesive may be used to join the first structure with the second structure to ensure an electrical path between the two structures. Welding may also be used to form a more robust connection between the two structures and maintain the electrical continuity.

Moreover, certain aspects of the disclosure are directed to techniques for bonding e-coated structures that utilize a combination of the cured coating and an adhesive to provide a relatively stronger bond between two structures while maintaining the protection provided by the cured coating. For example, an e-coating process may be applied to both a first structure and a second structure such that the surfaces of the two structures are provided with a protective coating. The two structures may then be joined by applying an adhesive (e.g., a carbon-base adhesive applied by a robot) to the coated surface of at least one of the structures and joining the two structures at the location of the adhesive. In some examples, the structures may be designed such that a region of the first structure is defined by a tongue characteristic and a region of the second structure is defined by a groove characteristic. Accordingly, the structures may be mechanically joined via a tongue-and-groove connection wherein the adhesive forms a layer between the protective coating of each respective structure in the tongue and groove connection.

Each of the structures described herein may be constructed of a metal material (e.g., aluminum, steel, copper, brass, etc.) and/or another electrically conductive material such as a metal alloy. As described herein, coating may relate to any protective coating of the structures, including an e-coating, anodizing, a self-assembled monolayer (SAM), or any other suitable coating for protecting a bare metal surface of one or more of the structures.

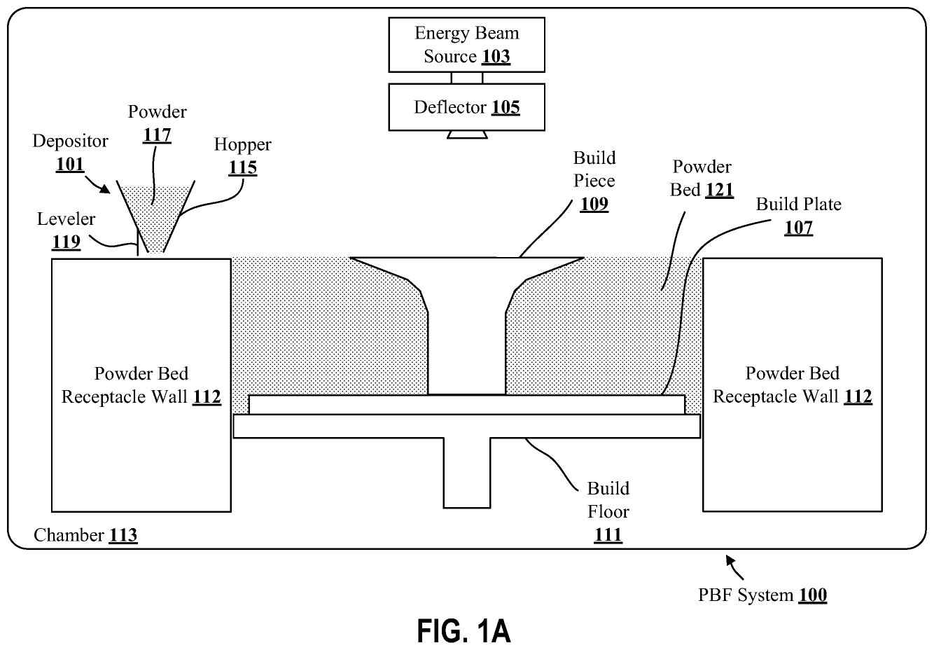

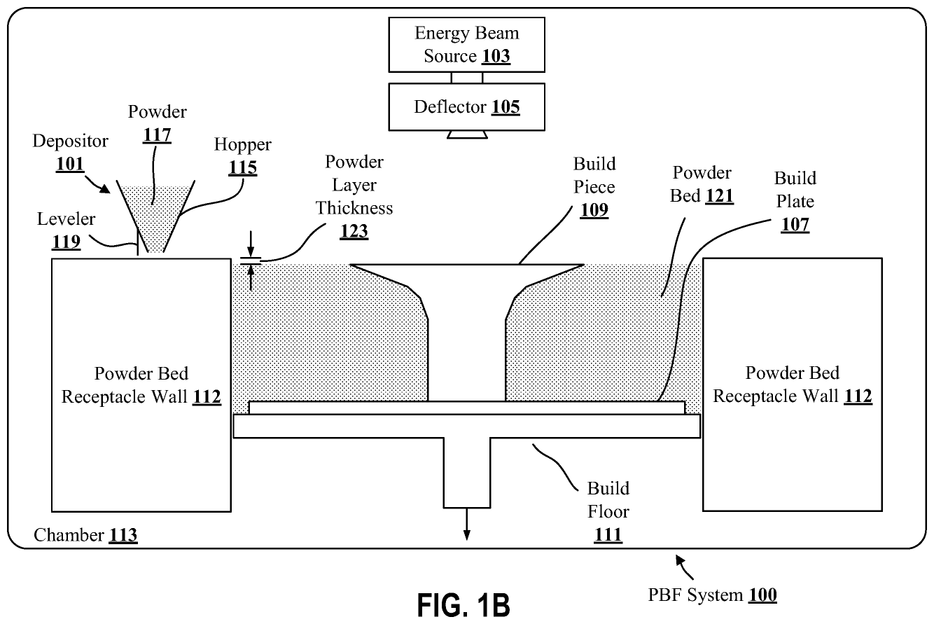

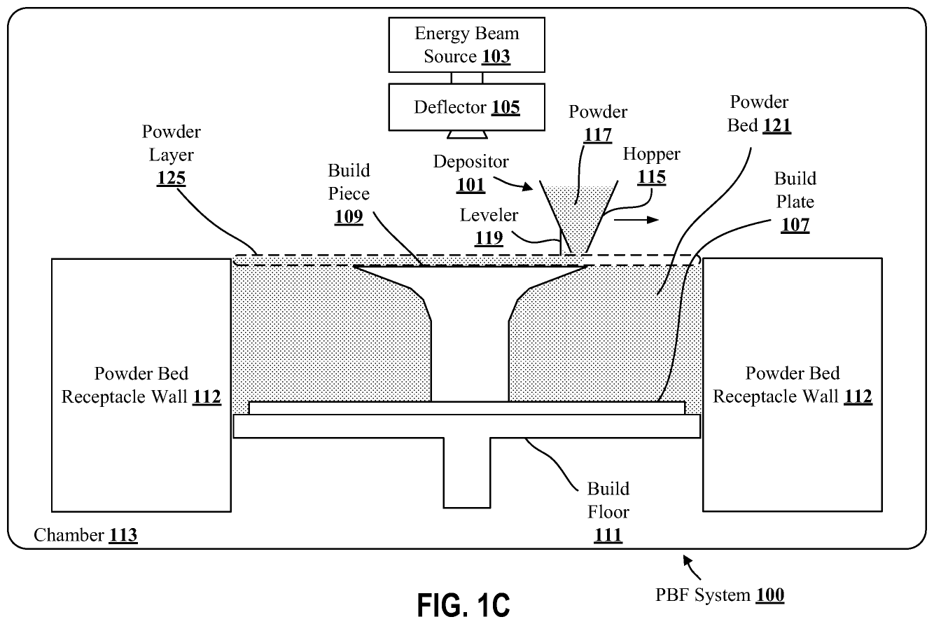

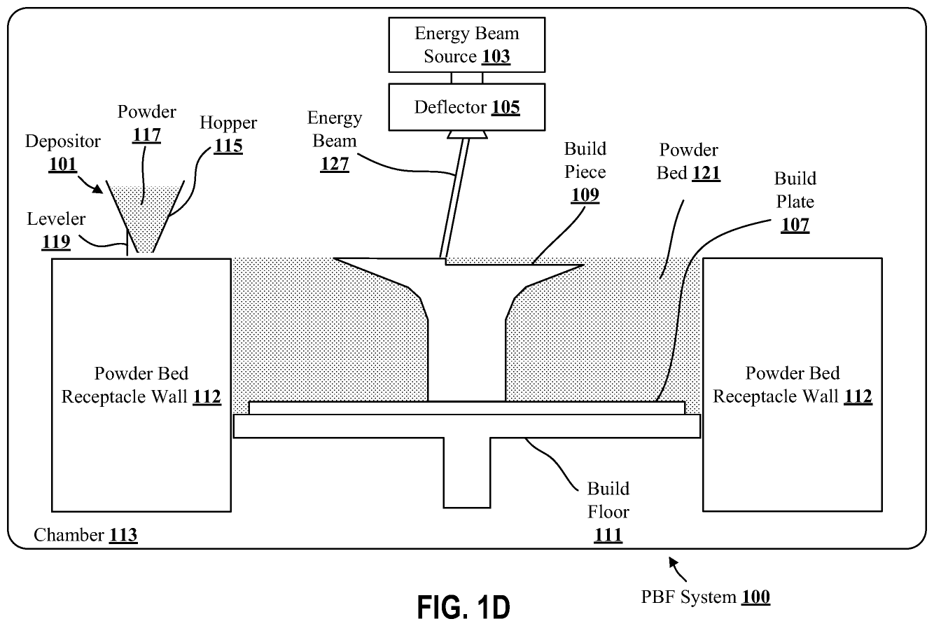

FIGS. 1A-D illustrate respective side views of an example powder-bed fusion PBF system 100 during different stages of operation. The particular embodiment illustrated in FIGS. 1A-D is one of many suitable examples of a PBF system employing the additive manufacturing principles of this disclosure. It should also be noted that elements of FIGS. 1A-D and the other figures in this disclosure are not necessarily drawn to scale but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various example embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

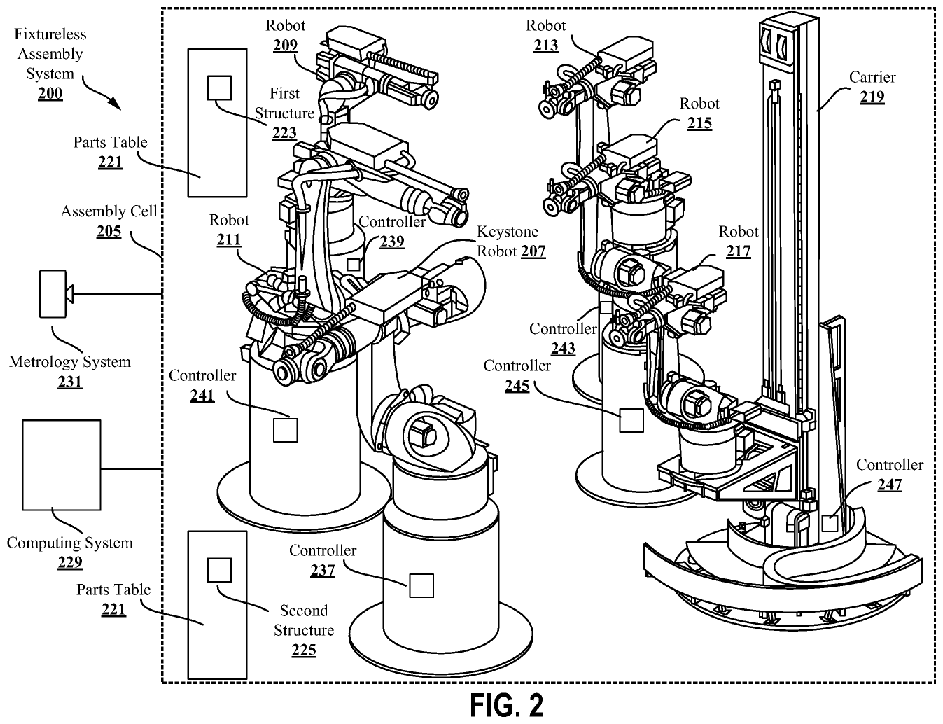

FIG. 2 illustrates a perspective view of an example of a fixtureless assembly system 200. The particular embodiment illustrated in FIG. 2 is one of many suitable examples of an assembly system employing the node-based assembly principles of this disclosure. Fixtureless assembly system 200 may be employed in various operations associated with fixtureless assembly of a vehicle, such as robotic assembly of a node-based vehicle. Fixtureless assembly system 200 may include one or more elements associated with at least a portion of the assembly of a vehicle without any fixtures. For example, one or more elements of fixtureless assembly system 200 may be configured for one or more operations in which a first structure is joined with one or more other structures without the use of any fixtures during robotic assembly of a node-based vehicle.

An assembly cell 205 may be configured at the location of fixtureless assembly system 200. Assembly cell 205 may be a vertical assembly cell. Within assembly cell 205, fixtureless assembly system 200 may include a set of robots 207, 209, 211, 213, 215, 217. Robot 207 may be referred to as a keystone robot. Fixtureless assembly system 200 may include parts tables 221 that can hold parts and structures for the robots to access. For example, a first structure 223 and a second structure 225 may be positioned on one of parts tables 221 to be picked up by the robots and assembled together. In various embodiments, one or more of the structures can be an additively manufactured structure, such as a complex node (e.g., chassis structure), as described in FIGS. 1A-1D above.

Fixtureless assembly system 200 may also include a computing system 229 to issue commands to the various controllers of the robots of assembly cell 205. In this example, computing system 229 is communicatively connected to the robots through wireless communication. Fixtureless assembly system 200 may also include a metrology system 231 that can accurately measure the positions of the robotic arms of the robots and/or the structures held by the robots.

In contrast to conventional robotic assembly factories, structures can be assembled without fixtures in fixtureless assembly system 200. For example, structures need not be connected within any fixtures, such as the fixtures described above. Instead, at least one of the robots in assembly cell 205 may provide the functionality expected from fixtures. For example, robots may be configured to directly contact (e.g., using an end effector of a robotic arm) structures to be assembled within assembly cell 205 so that those structures may be engaged and retained without any fixtures. Further, at least one of the robots may provide the functionality expected from the positioner and/or fixture table. For example, keystone robot 207 may replace a positioner and/or fixture table in fixtureless assembly system 200.

Keystone robot 207 may include a base and a robotic arm. The robotic arm may be configured for movement, which may be directed by computer-executable instructions loaded into a processor communicatively connected with keystone robot 207. Keystone robot 207 may contact a surface of assembly cell 205 (e.g., a floor of the assembly cell) through the base.

Keystone robot 207 may include and/or be connected with an end effector that is configured to engage and retain a first structure, e.g., a portion of a vehicle. An end effector may be a component configured to interface with at least one structure. Examples of the end effectors may include jaws, grippers, pins, or other similar components capable of facilitating fixtureless engagement and retention of a structure by a robot. In some embodiments, the first structure may be a section of a vehicle chassis, body, frame, panel, base piece, and the like. For example, the first structure may comprise a floor panel.

In some embodiments, keystone robot 207 may retain the connection with a first structure through an end effector while a set of other structures is connected (either directly or indirectly) to the first structure. Keystone robot 207 may be configured to engage and retain the first structure without any fixtures—e.g., none of the fixtures described above may be present in fixtureless assembly system 200. In some embodiments, structures to be retained by at least one of the robots (e.g., the first structure) may be additively manufactured or co-printed with one or more features that facilitate engagement and retention of those structures by the at least one of the robots without the use of any fixtures.

In retaining the first structure, keystone robot 207 may position (e.g., move) the first structure; that is, the position of the first structure may be controlled by keystone robot 207 when retained by the keystone robot. Keystone robot 207 may retain the first structure by holding or grasping the first structure, e.g., using an end effector of a robotic arm of the keystone robot. For example, keystone robot 207 may retain the first structure by causing gripper fingers, jaws, and the like to contact one or more surfaces of the first structure and apply sufficient pressure thereto such that the keystone robot controls the position of the first structure. That is, the first structure may be prevented from moving freely in space when retained by keystone robot 207, and movement of the first structure may be constrained by the keystone robot. As described above, the first structure may include one or more features that facilitates the fixtureless engagement and retention of the first structure by keystone robot 207.

As other structures (including subassemblies, substructures of structures, etc.) are connected to the first structure, keystone robot 207 may retain the engagement with the first structure through the end effector. The aggregate of the first structure and one or more structures connected thereto may be referred to as a structure itself, but may also be referred to as an assembly or a subassembly. Keystone robot 207 may retain an engagement with an assembly once the keystone robot has engaged the first structure.

In some embodiments, robots 209 and 211 of assembly cell 205 may be similar to keystone robot 207 and, thus, may include respective end effectors configured to engage with structures that may be connected with the first structure when retained by the keystone robot. In some embodiments, robots 209, 211 may be referred to as assembly robots and/or materials handling robots.

In some embodiments, robot 213 of assembly cell 205 may be used to affect a structural connection between the first structure and the second structure. For instance, robot 213 may be referred to as a structural adhesive robot. Structural adhesive robot 213 may be similar to the keystone robot 207, except the structural adhesive robot may include a tool at the distal end of the robotic arm that is configured to apply structural adhesive to at least one surface of structures fixturelessly retained by the keystone robot and structures fixturelessly retained by assembly robots 209, 211 before or after the structures are positioned at joining proximities with respect to other structures for joining with the other structures. The joining proximity can be a position that allows a first structure to be joined to a second structure. For example, in various embodiments, the first and second structures may be joined though the application of an adhesive while the structures are within the joining proximity and subsequent curing of the adhesive.

In various embodiments a quick-cure adhesive may be additionally applied to join the structures quickly and retain the structures so that the structural adhesive can cure without requiring both robots to hold the structures. In this regard, robot 215 of fixtureless assembly system 200 may be used to apply quick-cure adhesive and to cure the adhesive quickly. In this example embodiment, a quick-cure, electrically conductive UV adhesive may be used, and robot 215 may be referred to as a UV robot. UV robot 215 may be similar to keystone robot 207, except the UV robot may include a tool at the distal end of the robotic arm that is configured to apply a quick-cure UV adhesive and to cure the adhesive, e.g., when the first structure is positioned within the joining proximity with respect to the second structure. That is, UV robot 215 may cure an adhesive after the adhesive is applied to the first structure and/or second structure when the structures are within the joining proximity obtained through direction of at least one of the robotic arms of keystone robot 207 and/or assembly robots 209, 211.

In various embodiments, a robot may be used for multiple different roles. For example, robot 217 may perform the role of an assembly robot, such as assembly robots 209, 211, and the role of a UV robot, such as UV robot 215. In this regard, robot 217 may be referred to as an “assembly/UV robot.” Assembly/UV robot 217 may offer functionality similar to each of the assembly robots 209, 211 when the distal end of the robotic arm of the assembly/UV robot includes an end effector (e.g., connected by means of a tool flange). However, assembly/UV robot 217 may offer functionality similar to UV robot 215 when the distal end of the robotic arm of the assembly/UV robot includes a tool configured to applied UV adhesive and to emit UV light to cure the UV adhesive.

The quick-cure adhesive applied by UV robot 215 and assembly/UV robot 217 may provide a partial adhesive bond in that the adhesive may retain the relative positions of a first structure and a second structure within the joining proximity until the structural adhesive may be cured to permanently join the first structure and the second structure.

In assembling at least a portion of a vehicle in assembly cell 205, the second structure may be joined directly to the first structure by directing the various fixtureless robots 207, 209, 211, 213, 215, 217. Additional structures may be indirectly joined to the first structure. For example, the first structure may be directly joined to the second structure through movement(s) of keystone robot 207, structural adhesive robot 213, at least one assembly robot 209, 211, and/or UV robot 215. Thereafter, the first structure, joined with the second structure, may be indirectly joined to an additional structure as the additional structure is directly joined to the second structure. Thus, the first structure, which may continue to be retained by keystone robot 207, may evolve throughout an assembly process as additional structures are directly or indirectly joined to it.

In some embodiments, assembly robots 209, 211 may fixturelessly join two or more structures together, e.g., with a partial, quick-cure adhesive bond, before fixturelessly joining those two or more structures with the first structure retained by keystone robot 207. The two or more structures that are joined to one another prior to being joined with a structural assembly may also be a structure, and may further be referred to as a subassembly. Accordingly, when a structure forms a portion of a structural subassembly that is connected with the first structure through movements of keystone robot 207, structural adhesive robot 213, at least one assembly robot 209, 211, and UV robot 215, a structure of the structural subassembly may be indirectly connected to the first structure when the structural subassembly is joined to a structural assembly including the first structure.

In some embodiments, the structural adhesive may be applied, e.g., deposited in a groove of one of the structures, before the first and second structures are brought within the joining proximity. For example, structural adhesive robot 213 may include a dispenser for a structural adhesive and may apply the structural adhesive prior to the structures being brought within the joining proximity. In some embodiments, a structural adhesive may be applied after a structural assembly is fully constructed (that is, once each structure of the portion of the vehicle is joined to the first structure). For example, the structural adhesive may be applied to one or more joints or other connections between the first structure and the second structure. In some embodiments, the structural adhesive may be applied separately from fixtureless assembly system 200.

After the assembly is complete, i.e., all of the structures have been assembled, retained with a partial adhesive bond, with structural adhesive having been applied, the structural adhesive may be cured. Upon curing the structural adhesive, the portion of the vehicle may be completed and, therefore, may be suitable for use in the vehicle. For example, a completed structural assembly may meet any applicable industry and/or safety standards defined for consumer and/or commercial vehicles.

According to various embodiments, one or more of robots 207, 209, 211, 213, 215, 217 may be secured to a surface of assembly cell 205 through a respective base of each of the robots. For example, one or more of the robots may have a base that is bolted to the floor of the assembly cell. In various other embodiments, one or more of the robots may include or may be connected with a component configured to move the robot within assembly cell 205. For example, a carrier 219 in assembly cell 205 may be connected to assembly/UV robot 217.

Each of robots 207, 209, 211, 213, 215, 217 may include features that are common across all or some of the robots. For example, all of the robots may include a base, each of which having a surface (e.g., a bottom surface) that contacts assembly cell 205 (e.g., rests on or is secured to a floor of the assembly cell). Each base may have another surface (e.g., a top surface and/or a surface disposed on the base opposite from the surface contacting assembly cell 205) and, at a respective other surface, a base may connect with a proximal end of a respective robotic arm of a respective one of the robots.

In some embodiments, a base may be connected to the proximal end of a robotic arm through at least one rotation and/or translation mechanism. The at least one rotation and/or translation mechanism may provide at least one degree of freedom in movement of an end effector or other tool of the robotic arm. Correspondingly, the at least one rotation and/or translation mechanism may provide at least one degree of freedom in movement of a structure that is engaged and retained by an end effector or other tool of the robotic arm.

Each robotic arm of robots 207, 209, 211, 213, 215, 217 may include a distal end, oppositely disposed from the proximal end of the robotic arm. Each robotic arm of each of the robots may include an end effector and/or a tool, such as an adhesive application tool, curing tool, and so forth. An end effector or a tool may be at the distal end of a robotic arm. In some embodiments, the distal end of a robotic arm may be connected to an end effector or a tool (or tool flange) through at least one rotation and/or translation mechanism, which may provide at least one degree of freedom in movement of the tool and/or movement of a structure engaged and retained by the tool of the robotic arm.

In some embodiments, the distal end of a robotic arm may include a tool flange, and a tool included at the tool flange; for example, a tool may be connected to the distal end of a robotic arm by means of the tool flange. A tool flange may be configured to include a plurality of tools. In this way, for example, the assembly/UV robot 217 may offer functionality similar to each of the assembly robots 209, 211 when a distal end of a robotic arm of the assembly/UV robot 217 includes an end effector (e.g., connected by means of the tool flange). In addition, the assembly/UV robot 217 may offer functionality similar to the UV robot 215 when the distal end of the robotic arm of the assembly/UV robot 217 includes a tool configured to apply UV adhesive and to emit UV light to cure the adhesive.

According to some embodiments, a tool flange and/or tool may provide one or more additional degrees of freedom for rotation and/or translation of a structure engaged and retained by the tool. Such additional degrees of freedom may supplement the one or more degrees of freedom provided through one or more mechanisms connecting a base to the proximal end of a robotic arm and/or connecting the distal end of a robotic arm to the tool (or tool flange). Illustratively, a robotic arm of at least one of robots 207, 209, 211, 213, 215, 217 may include at least one joint configured for rotation and/or translation at a distal and/or proximal end, such as an articulating joint, a ball joint, and/or other similar joint.

One or more of the respective connections of robots 207, 209, 211, 213, 215, 217 (e.g., one or more rotational and/or translational mechanisms connecting various components of one of the robots), a respective tool flange, and/or a respective tool may provide at least a portion (and potentially all) of six degrees of freedom (6DoF) for a structure engaged and retained by the robots. The 6DoF may include forward/backward (e.g., surge), up/down (e.g., heave), left/right (e.g., sway) for translation in space and may further include yaw, pitch, and roll for rotation in space. Access to various portions of a structure may be attainable through one or more of the 6DoF, as opposed to retention of a structure using a fixture, which cannot offer 6DoF in movement of a structure and also blocks access to an significant portion of a structure attached thereto.

Each of the robots 207, 209, 211, 213, 215, 217 may be communicatively connected with a controller, such as a respective one of controllers 237, 239, 241, 243, 245, 247 shown in FIG. 2. Each of controllers 237, 239, 241, 243, 245, 247 may include, for example, a memory and a processor communicatively connected to the memory. According to some other embodiments, one or more of controllers 237, 239, 241, 243, 245, 247 may be implemented as a single controller that is communicatively connected to one or more of the robots controlled by the single controller.

Computer-readable instructions for performing fixtureless assembly can be stored on the memories of controllers 237, 239, 241, 243, 245, 247, and the processors of the controllers can execute the instructions to cause robots 207, 209, 211, 213, 215, 217 to perform various fixtureless operations, such as those described above.

Controllers 237, 239, 241, 243, 245, 247 may be communicatively connected to one or more components of an associated robot 207, 209, 211, 213, 215, or 217, for example, via a wired (e.g., bus or other interconnect) and/or wireless (e.g., wireless local area network, wireless intranet) connection. Each of the controllers may issue commands, requests, etc., to one or more components of the associated robot, for example, in order to perform various fixtureless operations.

According to some embodiments, controllers 237, 239, 241, 243, 245, 247 may issue commands, etc., to a robotic arm of the associated robot 207, 209, 211, 213, 215, or 217 and, for example, may direct the robotic arms based on a set of absolute coordinates relative to a global cell reference frame of assembly cell 205. In various embodiments, controllers 237, 239, 241, 243, 245, 247 may issue commands, etc., to tools connected to the distal ends of the robotic arms. For example, the controllers may control operations of the tool, including depositing a controlled amount of adhesive on a surface of the first structure or second structure by an adhesive applicator, exposing adhesive deposited between structures to UV light for a controlled duration by a curing tool, and so forth. In various embodiments, controllers 237, 239, 241, 243, 245, 247 may issue commands, etc., to end effectors at the distal ends of the robotic arms. For example, the controllers may control operations of the end effectors, including, engaging, retaining, and/or manipulating a structure.

According to various other aspects, a computing system, such as computing system 229, similarly having a processor and memory, may be communicatively connected with one or more of controllers 237, 239, 241, 243, 245, 247. In various embodiments, the computing system may be communicatively connected with the controllers via a wired and/or wireless connection, such as a local area network, an intranet, a wide area network, and so forth. In some embodiments, the computing system may be implemented in one or more of controllers 237, 239, 241, 243, 245, 247. In some other embodiments, the computing system may be located outside assembly cell 205.

The processor of the computing system may execute instructions loaded from memory, and the execution of the instructions may cause the computing system to issue commands, etc., to the controllers 237, 239, 241, 243, 245, 247, such as by transmitting a message including the command, etc., to one of the controllers over a network connection or other communication link.

According to some embodiments, one or more of the commands may indicate a set of coordinates and may indicate an action to be performed by one of robots 207, 209, 211, 213, 215, 217 associated with the one of the controllers that receives the command. Examples of actions that may be indicated by commands include directing movement of a robotic arm, operating a tool, engaging a structure by an end effector, rotating and/or translating a structure, and so forth. For example, a command issued by a computing system may cause controller 239 of assembly robot 209 to direct a robotic arm of assembly robot 209 so that the distal end of the robotic arm may be located based on a set of coordinates that is indicated by the command.

The instructions loaded from memory and executed by the processor of the computing system, which cause the controllers to control actions of the robots may be based on computer-aided design (CAD) data. For example, a CAD model of assembly cell 205 (e.g., including CAD models of the physical robots) may be constructed and used to generate the commands issued by the computing system.

Accordingly, in one example of a fixtureless assembly process, multiple robots (e.g., robots 207, 209, 211, 213, 215, and/or 217) are controlled (e.g., by computing system 229 and/or one or more controller(s) 237, 239, 241, 243, 245, 247) to join two structures together within an assembly cell (e.g., a vertical assembly cell such as assembly cell 205). The assembly operations may be performed repeatedly so that multiple structures may be joined for fixtureless assembly of at least a portion of a vehicle (e.g., vehicle chassis, body, panel, and the like). A first material handling robot (e.g., robot 209) may retain (e.g., using an end effector) a first structure (e.g., first structure 223) that is to be joined with a second structure (e.g., second structure 225) similarly retained by a second material handling robot (e.g., robot 211). A structural adhesive dispensing robot (e.g., robot 213) may apply structural adhesive to a surface of the first structure retained by the first robot. The first material handling robot may then position the first structure at a joining proximity with respect to the second structure retained by the second material handling robot. A metrology system (e.g., metrology system 231) may implement a move-measure-correct (MMC) procedure to accurately measure, correct, and move the robotic arms of the robots and/or the structures held by the robots into optimal positions at the joining proximity (e.g. using laser scanning and/or tracking).

The positioned structures (e.g., structures 223, 225) may then be joined together using the structural adhesive and cured (e.g., over time or using heat). However, as the curing rate of the structural adhesive may be relatively long, a quick-cure adhesive robot (e.g., robot 215 or robot 217) additionally applies a quick-cure adhesive to the first and/or second structures when the first and second structures are within the joining proximity, and then the quick-cure adhesive robot switches to an end-effector which emits electromagnetic (EM) radiation (e.g. ultraviolet (UV) radiation) onto the quick-cure adhesive. For example, the quick-cure adhesive robot may apply UV adhesive strips across the surfaces of the first and/or second structures such that the UV adhesive contacts both structures, and then the robot may emit UV radiation onto the UV adhesive strips. Upon exposure to the EM radiation, the quick-cure adhesive cures at a faster curing rate than the curing rate of the structural adhesive, thus allowing the first and second structure to be retained in their relative positions without fixtures so that the robots may quickly attend to other tasks (e.g., retaining and joining other parts) without waiting for the structural adhesive to cure. Once the structural adhesive cures, the first and second structures are bonded with structural integrity.

However, as the first and second structures in the joining proximity may be oriented in a variety of positions, the UV adhesive strips contacting the surface(s) may occasionally move (e.g., drip off). For instance, one structure may be positioned upside-down relative to another structure, and the UV adhesive may therefore drip off due to gravity. As a result, when the UV adhesive is cured, the first and second structures may be inadvertently retained in positions that do not provide acceptable tolerance, impacting the structural integrity of the assembly.

Difficulties in applying UV adhesive at the joining proximity may also cause improper retention of structures. For example, the material handling robots retaining the first and second structures in the joining proximity may be tightly packed in the assembly cell. As a result, a quick-cure adhesive robot may have difficulty maneuvering around the material handling robots and applying the UV adhesive to the structures in the joining proximity within this tightly packed area. Moreover, since the metrology system may also be using laser tracking to perform MMC for these structures in this tightly packed area, the quick-cure adhesive robot may potentially obstruct the lasers and the MMC process when attempting to apply the UV adhesive. As a result, the entire assembly may be impacted. For instance, when assemblies are formed by stacking different parts, the misalignment of one structure may affect the alignment of other parts which the structure supports. Additionally, since structures and subassemblies are frequently moved during the assembly process, an improper retention may cause the structures or subassemblies to deflect or drop from the assembly.

### Example Techniques for Bonding Multiple Coated Structures

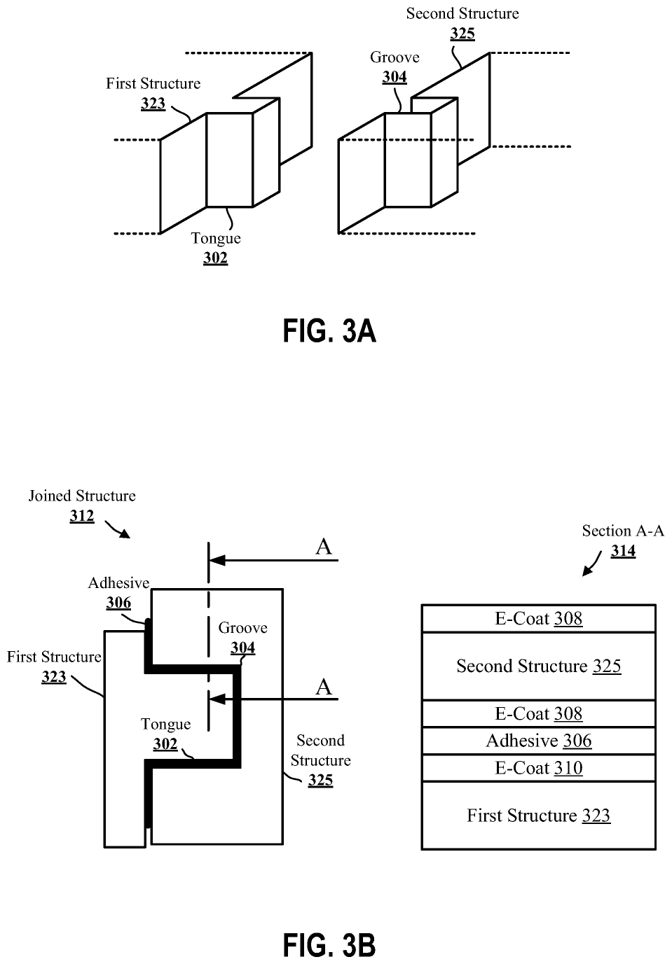

FIG. 3A is a perspective view of a first structure 323 (e.g., first structure 223 of FIG. 2) and a second structure 325 (e.g., first structure 225 of FIG. 2). The particular embodiment illustrated in FIG. 3A is one of many suitable examples of joining two or more coated (e.g., e-coated) metal structures described in this disclosure. Each of the first structure 323 and the second structure 325 may be a metal structure (e.g., aluminum, steel, copper, brass, etc.) and/or another electrically conductive material such as a metal alloy. Each of the first structure 323 and the second structure 325 may be at least partially covered by a protective coating formed via an e-coating process, and anodizing process, a self-assembled monolayer (SAM) process, or any other process for forming a protective coating on a bare metal surface of the first structure 323 and the second structure 325.

In this example, a portion of the first structure 323 is defined by a protrusion or a “tongue” 302 and the second structure 325 is defined by a cavity or a “groove” 304. The tongue 302 and groove 304 portions may be configured to form a tongue-and-groove connection between the first structure 323 and the second structure 325. The surface of the tongue 302 and the groove 304 portions of first structure 323 and the second structure 325 may be coated with a protective coating.

FIG. 3B is a block diagram illustrating an example of an apparatus or joined structure 312 comprising the first structure 323 and the second structure 325, and a section perspective 314 of the joined structure 312. As illustrated by the joined structure 312, the first structure 323 and the second structure 325 are bonded by an adhesive (e.g., any suitable adhesive material including an organic, carbon-based adhesive). In some examples, the adhesive is applied to surface of the protective coating of the tongue 302 and/or groove 304 portions of the structures by a structural adhesive dispensing robot (e.g., robot 213 of FIG. 2).

The section perspective 314 illustrates the multiple layers of the A-A section of the joined structure 312. Starting from the top layer of the section perspective 314 and working downward, a first e-coating 308 is the first layer, being a top layer of the second structure 325 of the joined structure 312. A second layer is the second structure 325 (e.g., a metallic structure). A third layer is the first e-coating 308, wherein the third layer is part of the groove 304 section of the second structure 325. A fourth layer is the adhesive 306 which bonds the first e-coating 308 of the second structure 325 to a second e-coating 310 of the first structure 323. Here, the second e-coating is a fifth layer of the section perspective 314. A sixth layer is the first structure 323 upon which the second e-coating 310 is formed.

Accordingly, as illustrated in the examples of FIGS. 3A and 3B, a surface of each of the first structure 323 and the second structure 325 may be coated with a protective coating prior to bonding or joining the structures. As such, the strength of the bond between the first structure 323 and the second structure 325 may be stronger than a bond without the first e-coating 308 and/or the second e-coating. Moreover, by applying the protective coating over each structure prior to joining the structures, the space required to perform the protective coating process is reduced significantly because the individual structures 323/325 are smaller than the jointed structure 312. Although FIGS. 3A and 3B illustrate an example of a tongue-and-groove joint, any suitable joint configuration may be used, including socket joints, flanged joints, half-lap joints, biscuit joints, rabbet joints, etc.

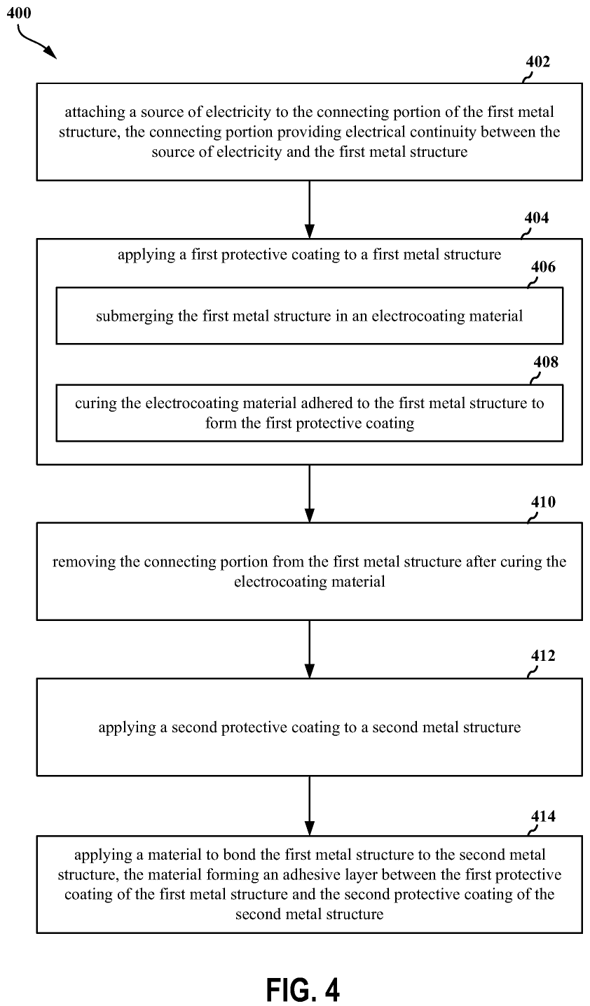

FIG. 4 is a flow diagram 400 illustrating an example method for coating multiple metal structures (e.g., first structure 323 and second structure 325) and bonding the multiple coated structures. It should be noted that one or more elements of the flow diagram 400 may be performed by the fixtureless assembly system 200 of FIG. 2.

A block 402 includes attaching a source of electricity to the connecting portion of the first metal structure, the connecting portion providing electrical continuity between the source of electricity and the first metal structure. For example, a user may attach a clamp to the first metal structure so that a conductive surface of the clamp contacts the metal surface of the first metal structure. The clamp may be electrically connected to a power source and configured to pass a current to the first metal structure via the contact.

A block 404 includes applying a first protective coating to a first metal structure. Block 404 may also include a block 406 for submerging the first metal structure in an electrocoating material, and a block 408 for curing the electrocoating material adhered to the first metal structure to form the first protective coating. For example, the first metal structure may be submerged in the electrocoating material, and a current may be passed through the first metal structure via the clamp. As a result, particles of the electrocoating material may be drawn to the portions of the surface of the first metal structure that are exposed to the electrocoating material.

A block 410 includes removing the connecting portion from the first metal structure after curing the electrocoating material. It should be noted that once the connecting portion (e.g., clamp) is removed from the first metal structure, the portion of the surface that the clamp was in contact with will be bare metal and will not have an e-coating protection. In some examples, the bare metal portion (e.g., the unprotected portion of the first metal structure) may be manually filled in with a protective coating. In another example discussed in more detail below, the unprotected portion may be left unprotected. In such an example, the unprotected portion may be a piece of material configured to be removed from the first metal structure after the protective coating has been applied. In another example, the unprotected portion may be a piece of material internal to the first metal structure, or an external portion of material configured to connect to a second metal structure such that the bare, unprotected metal contacts another portion of unprotected metal in the second metal structure and provides electrical continuity between the two metal structures.

A block 412 includes applying a second protective coating to the second metal structure. For example, the aforementioned steps may be repeated for a second metal structure to protectively coat the second metal structure. As discussed in reference to block 410, the second metal structure may be first e-coated prior to coupling the first metal structure with the second metal structure to establish electrical continuity.

A block 414 includes applying a material to bond the first metal structure to the second metal structure, the material forming an adhesive layer between the first protective coating of the first metal structure and the second protective coating of the second metal structure. As discussed above in reference to FIG. 3B, a surface of each of the first metal structure and the second metal structure may be coated with a protective coating prior to bonding or joining the structures. In such an example, the strength of the bond between the first metal structure and the second metal structure may be stronger than a bond without the e-coating.

### Example Techniques for Applying a Protective Coating on a Structure

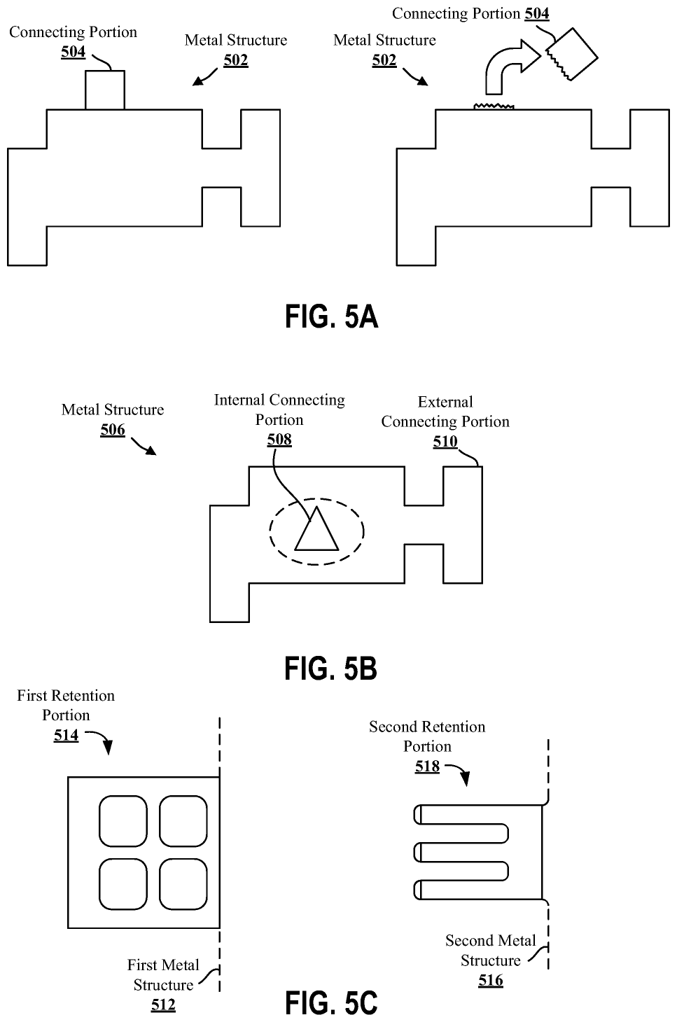

FIGS. 5A-5C are block diagrams illustrating example metal structures having attachment points to be used for attaching a source of electricity. As noted above, an e-coating process requires electrical continuity through the metal structure during the coating process. Conventionally, electrical continuity may be provided by clamps and/or manually applied wiring. However, any surface of the wire or the clamp that touches the metal part will obscure that portion of the metal part, preventing a complete coating and removal of the wire will often mar the coating. Thus, aspects of the disclosure are directed to techniques for applying a protective coating on a structure that include structure-specific design considerations. It should be noted that an protective coating (e.g., e-coating) may be applied to the metal structures illustrated in FIGS. 5A-5C using the method described in reference to FIG. 4.

For example, FIG. 5A illustrates an example apparatus or metal structure 502 that includes a connecting portion 504. It is appreciated that the metal structure 502 is an example and may include more than one connecting portions. Here, the connecting portion 504 may be coupled to the metal structure 502 and configured to provide electrical continuity between a source of electricity and the metal structure 502. For example, the connecting portion may be constructed of a conductive metal material. In certain aspects, the connecting portion 504 is structurally weaker than the remainder of the metal structure 502. In one example, a design of the metal structure 502 may be modified to add the connecting portion to the metal structure 502. Accordingly, if the metal structure 502 is manufactured via an additive manufacturing method, the connecting portion 504 can be easily added to the metal structure 502. In another example, the design of the connecting portion 504 may be modified relative to the design of the rest of the metal structure 502. Such a design modification may make removal of the connecting portion 504 easier.

In certain aspects, the design of the metal structure 502 may be modified so that the connecting portion 504 is configured to support the weight of the metal structure 502 or the weight of the metal structure 502 and one or more metal structures. Here, if multiple metal structures are bonded together, the connecting portion 504 may be required to support the weight of the multiple metal structures. In this example, the connecting portion 504 may be used as an attachment point for a clamp and provide electrical continuity between the clamp and the metal structure 502 in order to facilitate a e-coating process. If used for clamping the metal structure 502 for an e-coating process, the connecting portion 504 may not be submerged in the electrocoating material. Accordingly, the clamp will also not be submerged, and will not require cleaning or etching to remove the material from the clamp. In some examples, the connecting portion 504 may be a temporary feature of the metal structure 502. As illustrated in FIG. 5A, the connecting portion 504 may be removed from the metal structure 502 once it is no longer needed (e.g., after the metal structure 502 has been e-coated).

FIG. 5B illustrates an example apparatus or metal structure 506 that includes an internal connecting portion 508 and an external connecting portion 510. It is appreciated, however, that the metal structure 506 is an example, and may include more or fewer connecting portions. For example, the metal structure 506 may include only one of the internal connecting portion 508 or the external connecting portion 510.

In this example, the internal connecting portion 508 may be a permanent support piece (e.g., a lattice) internal to the metal structure 506. That is, a clamp may be attached to an internal piece of the metal structure 506 to provide electrical continuity to the structure. Because the part is internal (e.g., not an external surface) an e-coating may not be required. Here, wherein an internal surface may include the internal connecting portion 508. The external connecting portion 510 may be a permanent piece external to the metal structure 506. As with the connection portion 504 of FIG. 5A, the design of the metal structure 506 may be modified to ensure that one or more of the internal connecting portion 508 and the external connecting portion 510 may support the weight of the metal structure 506 or both the metal structure 506 and another structure bonded to the metal structure 506.

FIG. 5C illustrates an example of an apparatus or first metal structure 512 including a retention portion in the form of a groove (e.g., a recess, etc.) and another apparatus or second metal structure 516 including a retention feature in the form of a tongue (e.g., a projection, etc.). In some examples, the external connection portion 510 of FIG. 5B may include one of the first retention portion 514 and the second retention portion 518. That is, in some examples, a clamp may be attached to the first retention portion 514 and/or the second retention portion 518 to provide electrical continuity between the clamp and the first metal structure 512 and/or the second metal structure 516 for an e-coating process. Accordingly, the clamp may prevent the first retention portion 514 and the second retention portion 518 from being coated by the electrocoating material.

In some examples, the first metal structure 512 may be coupled to the second metal structure 516 via the first retention portion 514 and the second retention portion 518 after the e-coating has cured on the remaining surfaces of the structures. Because the first retention portion 514 and the second retention portion 518 are bare metal, attaching the structures by the retention portions may provide electrical continuity between the two structures. In certain aspects, this may be used to provide a chassis ground for an electrical system. In some examples, a curable adhesive (e.g., a UV activated quick cure adhesive) may be applied to a bare surface of the first retention portion 514 and/or the second retention portion 518 by a structural adhesive dispensing robot (e.g., robot 213 of FIG. 2) to attach the first metal structure 512 and the second metal structure 516.

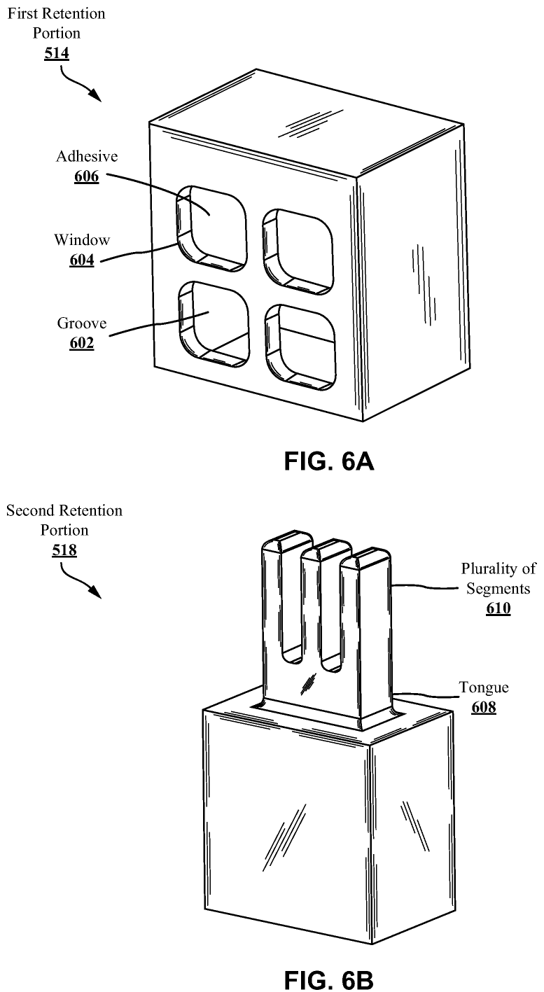

FIGS. 6A and 6B are example perspective views of the first retention portion 514 of FIG. 5C and the second retention portion 518 of FIG. 5C, respectively. The first retention portion includes a groove 602 in which an adhesive dispensing robot (e.g., robot 213, 215, or 217) may inject quick-cure adhesive 606. The first retention portion 514 may also include a window 604 (e.g., a translucent or transparent screen) opposite the groove in which a quick-cure adhesive robot may emit electro-magnetic (EM) or ultra-violet (UV) radiation to cure the adhesive 606 contained within the groove 602.

The second retention portion 518 included a tongue 608 which a material handling robot (e.g., robot 209 or 211) may place into the quick-cure adhesive within the groove 602 of the first retention portion 514. The tongue 608 may include a plurality of segments 610 spaced apart from each other or a plurality of openings (e.g., waffle shape) which contact the adhesive 606 when the tongue 608 is inserted into the groove 602.

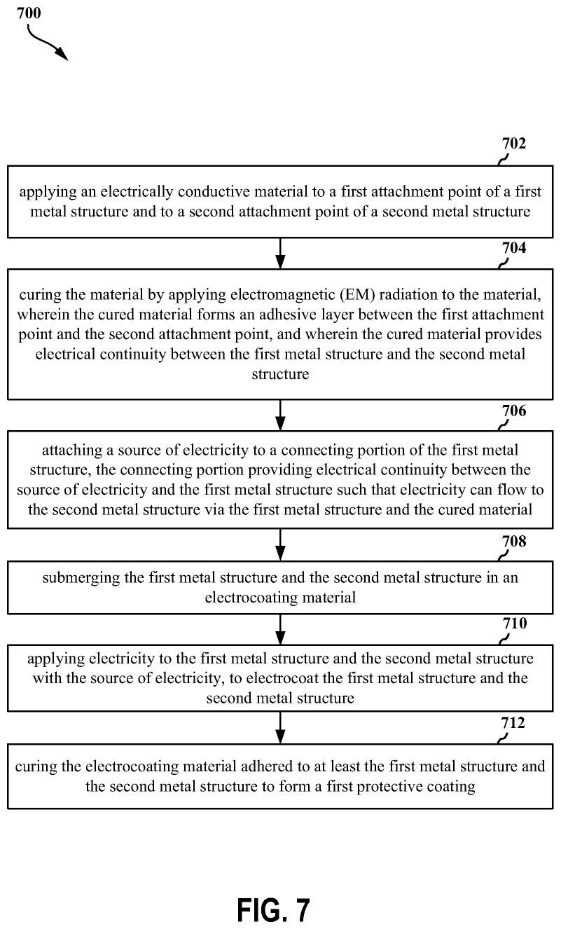

FIG. 7 is a flow diagram 700 illustrating an example method for bonding multiple metal structures (e.g., first structure 323 and second structure 325 of FIGS. 3A and 3B; metal structures 502, 506, 512, 516 of FIGS. 5A-5C) and coating the bonded metal structures with a protective e-coating. It should be noted that one or more elements of the flow diagram 700 may be performed by the fixtureless assembly system 200 of FIG. 2.

A block 702 includes applying an electrically conductive material to a first attachment point of a first metal structure and to a second attachment point of a second metal structure. Here, the electrically conductive material may include the quick-cure adhesive 606 of FIG. 6A, the first attachment point may relate to the first retention portion 514 of FIG. 6A, and the second attachment point may relate to the second retention portion 518 of FIG. 6B. In one example, the electrically conductive material is applied to the first attachment point of the first metal structure, and the second attachment point is inserted into the first attachment point such that the electrically conductive material is applied to both attachment points.

A block 704 includes curing the material by applying electromagnetic (EM) radiation to the material, wherein the cured material forms an adhesive layer between the first attachment point and the second attachment point, and wherein the cured material provides electrical continuity between the first metal structure and the second metal structure. Here, the electrically conductive material may be cured via EM (e.g., UV radiation) emitted through one or more windows (e.g., window 604 of FIG. 6A) of the first attachment point. By curing the electrically conductive material, the first metal structure and the second metal structure are bonded together and have electrical continuity between them. In this example, both the first metal structure and the second metal structure may be bare metal without a protective coating.

A block 706 includes attaching a source of electricity to a connecting portion of the first metal structure, the connecting portion providing electrical continuity between the source of electricity and the first metal structure such that electricity can flow to the second metal structure via the first metal structure and the cured material. Here, the connecting portion may include the connecting portion 504 of FIG. 5A, the internal connecting portion 508 or the external connecting portion 510 of FIG. 5B. Accordingly, a clamp may be attached to the connecting portion to provide electrical continuity to the bonded first metal structure and second metal structure so that a protective e-coating may be applied to the bonded structures.

A block 708 includes submerging the first metal structure and the second metal structure in an electrocoating material. Here, the bonded structures may be submerged in the electrocoating material as part of a process for applying a protective coating.

A block 710 includes applying electricity to the first metal structure and the second metal structure with the source of electricity, to electrocoat the first metal structure and the second metal structure. Here, the electricity may be applied to the bonded structure while it is submerged in the electrocoating material so that the material attaches itself to the structure.

A block 712 includes curing the electrocoating material adhered to at least the first metal structure and the second metal structure to form a first protective coating. Here, after the electrocoating material attaches itself to the structure, the structure may be placed into an oven or other heat source to complete the protective coating process.

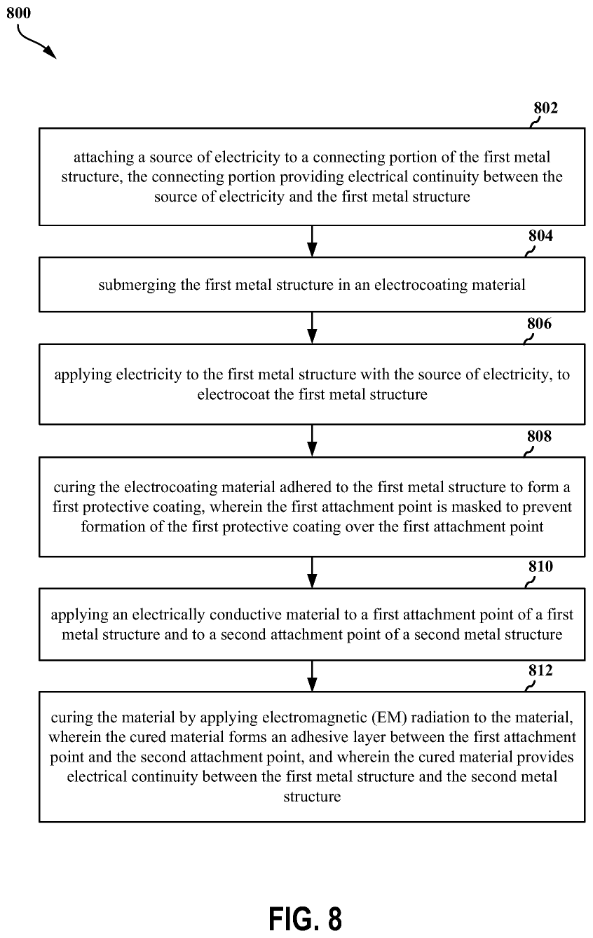

FIG. 8 is a flow diagram 800 illustrating an example method for bonding multiple metal structures (e.g., first structure 323 and second structure 325 of FIGS. 3A and 3B; metal structures 502, 506, 512, 516 of FIGS. 5A-5C) that have already been coated with a protective e-coating. It should be noted that one or more elements of the flow diagram 800 may be performed by the fixtureless assembly system 200 of FIG. 2.

A block 802 includes attaching a source of electricity to a connecting portion of the first metal structure, the connecting portion providing electrical continuity between the source of electricity and the first metal structure. Here, the connecting portion may include the connecting portion 504 of FIG. 5A, the internal connecting portion 508 or the external connecting portion 510 of FIG. 5B, or the first retention portion 514 and/or the second retention portion 518 of FIG. 5C. Accordingly, a clamp may be attached to the connecting portion to provide electrical continuity to the bonded first metal structure and second metal structure so that a protective e-coating may be applied to the bonded structures.

A block 804 includes submerging the first metal structure in an electrocoating material. Here, the bonded structures may be submerged in the electrocoating material as part of a process for applying a protective coating. It should be noted that if the first metal structure includes the first retention portion 514 or the second retention portion 518, the clamp may be applied to the corresponding retention portion in order to prevent the electrocoating material from contacting the retention portion. In this way, the retention portion may be defined by a bare metal surface after curing the electrocoating material, and may be used to bond to another retention portion of another structure and provide electrical continuity between the two structures. In this example, the connecting portion of the first metal structure may be the same as the first attachment point. In another example, the retention portion may be masked with any suitable material to prevent the electrocoating material from contacting the retention portion.

A block 806 includes applying electricity to the first metal structure with the source of electricity, to electrocoat the first metal structure. Here, the electricity may be applied to the bonded structure while it is submerged in the electrocoating material so that the material attaches itself to the structure.

A block 808 includes curing the electrocoating material adhered to the first metal structure to form a first protective coating, wherein the first attachment point is masked to prevent formation of the first protective coating over the first attachment point. Here, after the electrocoating material attaches itself to the structure, the structure may be placed into an oven or other heat source to complete the protective coating process. Any masking over the attachment point may be removed. For example, if the masking was provided by the clamp, the clamp may be removed prior to curing. However, if the masking was provided by a masking material, then the material may be removed after curing.

A block 810 includes applying an electrically conductive material to a first attachment point of a first metal structure and to a second attachment point of a second metal structure. The first attachment point and the second attachment point may correspond to the first retention portion 514 and the second retention portion 518 of FIG. 5C, respectively. In this example, although a protective coating has been applied to the first metal structure and the second metal structure, the first attachment point and the second attachment point maintain a bare metal surface due to masking. Here, the electrically conductive material may include the quick-cure adhesive 606 of FIG. 6A. In one example, the electrically conductive material is applied to the first attachment point of the first metal structure, and the second attachment point is inserted into the first attachment point such that the electrically conductive material is applied to both attachment points.

A block 812 includes curing the material by applying EM radiation to the material, wherein the cured material forms an adhesive layer between the first attachment point and the second attachment point, and wherein the cured material provides electrical continuity between the first metal structure and the second metal structure. Here, the electrically conductive material may be cured via EM (e.g., UV radiation) emitted through one or more windows (e.g., window 604 of FIG. 6A) of the first attachment point. By curing the electrically conductive material, the first metal structure and the second metal structure are bonded together and have electrical continuity between them. In this example, both the first metal structure and the second metal structure may be bare metal without a protective coating.

The previous description is provided to enable any person skilled in the art to practice the various aspects described herein. Various modifications to these example embodiments presented throughout this disclosure will be readily apparent to those skilled in the art. Thus, the claims are not intended to be limited to the example embodiments presented throughout the disclosure, but are to be accorded the full scope consistent with the language claims. All structural and functional equivalents to the elements of the example embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus comprising:
a first metal structure at least partially covered by a first protective coating;
a second metal structure at least partially covered by a second protective coating; and
a material bonding the first metal structure to the second metal structure, wherein the material forms an adhesive layer between the first protective coating of the first metal structure and the second protective coating of the second metal structure.

2. The apparatus of claim 1, wherein the first protective coating comprises a first anodized coating or a first electrocoating, and wherein the second protective coating comprises a second anodized coating or a second electrocoating.

3. The apparatus of claim 1, wherein a first portion of the first metal structure comprises a groove, the groove configured to receive a second portion of the second metal structure, wherein the first portion is covered with the first protective coating and the second portion is covered with the second protective coating, and wherein the material forms the adhesive layer between the first portion and the second portion.

4. The apparatus of claim 1, wherein the material configured to bond the first metal structure to the second metal structure is a first material, and wherein the apparatus further comprises a second material different from the first material configured to bond the first metal structure to the second metal structure, wherein the second material forms another adhesive layer between the first metal structure and the second metal structure.

5. The apparatus of claim 4, wherein the second material comprises an ultra-violet (UV) curable electrically conductive adhesive configured to provide electrical continuity between the first metal structure and the second metal structure.

6. The apparatus of claim 1, further comprising a connecting portion coupled to the first metal structure, the connecting portion configured to provide electrical continuity between a source of electricity and the first metal structure.

7. The apparatus of claim 6, wherein the connecting portion is structurally weaker than a remainder of the first metal structure.

8. The apparatus of claim 6, wherein the connecting portion is configured to support a weight of the first metal structure or a weight of both the first metal structure and the second metal structure.

9. The apparatus of claim 6, wherein the first metal structure comprises an outer surface and an internal surface, and wherein the internal surface comprises the connecting portion.

10. The apparatus of claim 1, wherein the first protective coating and the second protective coating are the same.

11. A method comprising:
applying a first protective coating to a first metal structure;
applying a second protective coating to a second metal structure; and
applying a material to bond the first metal structure to the second metal structure, the material forming an adhesive layer between the first protective coating of the first metal structure and the second protective coating of the second metal structure.

12. The method of claim 11, wherein applying the protective coating to the first metal structure comprises:
attaching a source of electricity to a connecting portion of the first metal structure, the connecting portion providing electrical continuity between the source of electricity and the first metal structure;
submerging the first metal structure in an electrocoating material; and
curing the electrocoating material adhered to the first metal structure to form the first protective coating.

13. The method of claim 12, wherein the first metal structure comprises an outer surface and an internal surface, and wherein the internal surface comprises the connecting portion.

14. The method of claim 12, further comprising removing the connecting portion from the first metal structure after curing the electrocoating material.

15. The method of claim 11, wherein the first protective coating comprises a first anodized coating or a first electrocoating, and wherein the second protective coating comprises a second anodized coating or a second electrocoating.

16. The method of claim 11, wherein the material forming the adhesive layer is a first material, and wherein the method further comprises:
applying a second material, the second material different from the first material, to bond the first metal structure to the second metal structure, wherein the second material forms another adhesive layer between a region of the first metal structure not including the first protective coating and a region of the second metal structure not including the second protective coating.

17. The method of claim 16, wherein the second material comprises an ultra-violet (UV) curable electrically conductive adhesive providing electrical continuity between the first metal structure and the second metal structure.

18. The method of claim 11, wherein a first portion of the first metal structure comprises a groove, the groove configured to receive a second portion of the second metal structure, wherein the first portion is covered with the first protective coating and the second portion is covered with the second protective coating, and wherein the material forms the adhesive layer between the first portion and the second portion.

19. The method of claim 11, wherein the first protective coating and the second protective coating are the same.

20. A method comprising:
applying an electrically conductive material to a first attachment point of a first metal structure and to a second attachment point of a second metal structure; and
curing the material by applying electromagnetic (EM) radiation to the material, wherein the cured material forms an adhesive layer between the first attachment point and the second attachment point, and wherein the cured material provides electrical continuity between the first metal structure and the second metal structure.

21. The method of claim 20, further comprising:
attaching a source of electricity to a connecting portion of the first metal structure, the connecting portion providing electrical continuity between the source of electricity and the first metal structure such that electricity can flow to the second metal structure via the first metal structure and the cured material;
submerging the first metal structure and the second metal structure in an electrocoating material;
applying electricity to the first metal structure and the second metal structure with the source of electricity, to electrocoat the first metal structure and the second metal structure; and
curing the electrocoating material adhered to at least the first metal structure and the second metal structure to form a first protective coating.

22. The method of claim 20, further comprising, prior to applying the electrically conductive material to the first attachment point of the first metal structure and to the second attachment point of the second metal structure:
attaching a source of electricity to a connecting portion of the first metal structure, the connecting portion providing electrical continuity between the source of electricity and the first metal structure;
submerging the first metal structure in an electrocoating material;
applying electricity to the first metal structure with the source of electricity, to electrocoat the first metal structure; and
curing the electrocoating material adhered to the first metal structure to form a first protective coating, wherein the first attachment point is masked to prevent formation of the first protective coating over the first attachment point.

23. The method of claim 20, wherein the electrically conductive material comprises an ultra-violet (UV) curable electrically conductive adhesive configured to provide electrical continuity between the first metal structure and the second metal structure, and wherein the EM radiation comprises ultraviolet (UV) radiation.

24. The method of claim 20, wherein the first metal structure comprises a connecting portion for attaching a source of electricity, the connecting portion providing electrical continuity between the source of electricity and the first metal structure.

25. The method of claim 24, wherein the connecting portion is structurally weaker than a remainder of the first metal structure.

26. The method of claim 25, further comprising removing the connecting portion from the first metal structure after forming a first protective coating over the first metal structure.

27. The method of claim 24, wherein the connecting portion is configured to support a weight of both of the first metal structure and the second metal structure.

28. The method of claim 24, wherein the first metal structure comprises an outer surface and an internal surface, and wherein the internal surface comprises the connecting portion.

29. The method of claim 20, wherein the first attachment point of the first metal structure comprises a groove at the first attachment point for receiving the second attachment point of the second metal structure.

30. The method of claim 29, wherein the first attachment point further comprises at least one window for EM radiation into the groove.
